(19) United States
(12) Patent Application Publication
(10) Pub. No.: US 2008/0006450 A1
(43) Pub. Date: Jan. 10, 2008

(54) Load Cell Having A Base With A Curved Surface

(76) Inventor: Gerald S. Simons, Toronto (CA)

Correspondence Address: HODGSON RUSS LLP;THE GUARANTY BUILDING, 140 PEARL STREET, SUITE 100, BUFFALO, NY, 14202-4040, US

(21) Appl. No.: 11/773,726

(22) Filed: Jul. 5, 2007

Related U.S. Application Data
(60) Provisional application No. 60/818,490, filed on Jul. 5, 2006.

(51) Int. Cl. G01G 3/14

(52) U.S. Cl. 177/211

(57) ABSTRACT

The invention includes a load cell which has a base with a curved surface, a strain gauge measuring device, and a transmission device. The strain gauge measuring device is fixed to the curved surface, and includes at least one strain gauge.

### CROSS-REFERENCE TO RELATED APPLICATION

This application claims priority to and the benefit of U.S. provisional patent application Ser. No. 60/818,490 filed on Jul. 5, 2006.

### FIELD OF THE INVENTION

The present invention relates to devices for measuring the weight of objects.

### BACKGROUND OF THE INVENTION

There are many situations in which it is desired to know the weight of an object. For example, when lifting a pallet, a forklift truck driver would like to know the weight of the pallet and/or the objects on the pallet in order to load the proper amount of the objects into a delivery truck. Or, it may be beneficial to know the weight being supported by a floor so that an alarm may be sounded when the weight supported by the floor exceeds a safe level. Further, the weight of vehicles is often needed in order to determine taxes due for driving on roadways or the cost of the goods being carried by the vehicle.

Often, weight sensors are placed in locations which allow for indirect measurement of the weight of objects being supported from a platform, such as a pallet or a floor. Indirect measurement is not very accurate, and usually requires complex devices to determine the weight. In other situations, weight sensors are placed directly beneath an object, but these mechanisms for supporting and measuring the weight of an object, such as a truck, are large and costly.

As such, there is a need for a load cell that is capable of directly measuring the weight of an object, and which is both inexpensive and occupies a small amount of space.

### SUMMARY OF THE INVENTION

The invention may be embodied as a load cell. The load cell may have a base having a curved surface and a strain gauge measuring device fixed to the curved surface. The curved surface of the base may be substantially symmetrical about a plurality of axes. For example, the base may be substantially spherical or substantially conical. The base may be a non-planar washer. The base is able to transmit a force exerted by an object to be weighed. The strain gauge measuring device may be a Wheatstone bridge.

The load cell may include a transmission device capable of transmitting a signal from the strain gauge measuring device to an analyzing circuit. The transmission device may include conductors extending between the load cells and the analyzing circuit. A hole may be provided in the curved surface in order to allow the conductors to extend through the curved surface. The conductors may be used to provide electric power to the strain gauge and/or to receive indications of resistance from the strain gauge.

The analyzing circuit may be a voltmeter. The voltmeter may be electrically coupled to a computer which is programmed to correlate changes indicated by the voltmeter to a weight, and also programmed to cause a monitor to indicate a weight to a person having a desire to know the weight of an object being weighed.

A first plate may be provided in contact with an end-edge of the curved surface. The first plate may support an object to be weighed, and in this manner, the first plate may transmit the weight of the object to the base. Such a plate is referred to herein as a “load-sending” plate.

A second plate may be provided in contact with another end-edge of the curved surface. The second plate may support the base, and in this manner, the second plate may transmit the weight of the object and the base to a supporting structure and eventually the ground. Such a plate is referred to herein as a “load-receiving” plate.

The base may have a hole extending through the base. The edges which define the hole provide a first end-edge surface, which may be used as a contact surface to support the load-sending plate. The load sending plate may be placed in contact with the first end-edge of the curved surface. An outer edge of the curved surface may provide a second end-edge surface, which may be used as a contact surface to transmit force to the load-receiving plate. The load-receiving plate may be placed in contact with a second end-edge of the curved surface. A fastener may be provided to extend through the plates and the hole so as to substantially fix the position of the plates relative to the base.

The invention may be embodied as a method of weighing. Such a method may include providing a load cell, such as that described above. A first resistance of the strain gauge measuring device may be measured before an object is placed on the load cell. Then an object to be weighed is supported with the base, and a second resistance of the strain gauge measuring device may be measured. Then, the first resistance is compared to the second resistance to obtain a resistance difference. The resistance difference is correlated to a weight, and the weight is displayed to a person having an interest in knowing the weight of the object.

### BRIEF DESCRIPTION OF THE DRAWINGS

For a fuller understanding of the nature and objects of the invention, reference should be made to the accompanying drawings and the subsequent description. Briefly, the drawings are:

FIG. 1a, which is a plan view of a base of a load cell according to the invention;

FIG. 1b, which is a bottom view of the base depicted in FIG. 1a;

FIG. 2a, which is a cross-sectional side view of a load cell taken along the line 2-2 in FIG. 1a;

FIG. 2b, which is a cross-sectional side view of another load cell taken along the line 2-2 in FIG. 1a;

FIG. 3, which is a cross-sectional side view of a load cell having a base like that depicted in FIG. 2a;

FIG. 4, which depicts a load cell system according to the invention; and

FIG. 5, which depicts a method according to the invention.

### FURTHER DESCRIPTION OF THE INVENTION

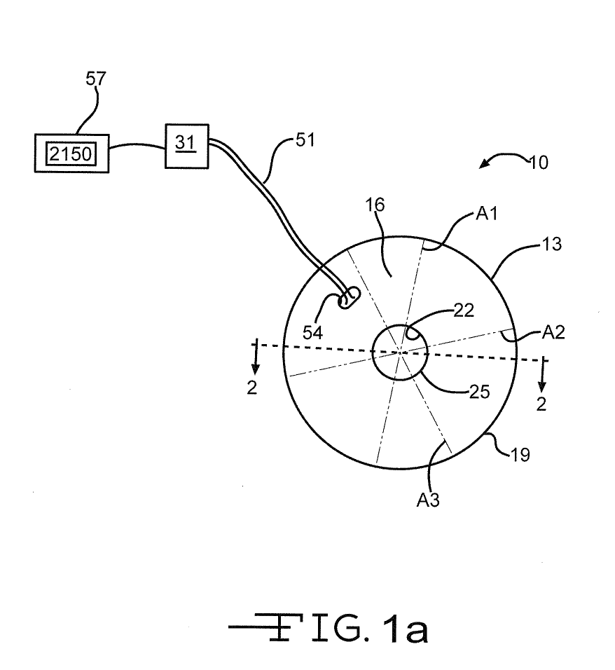

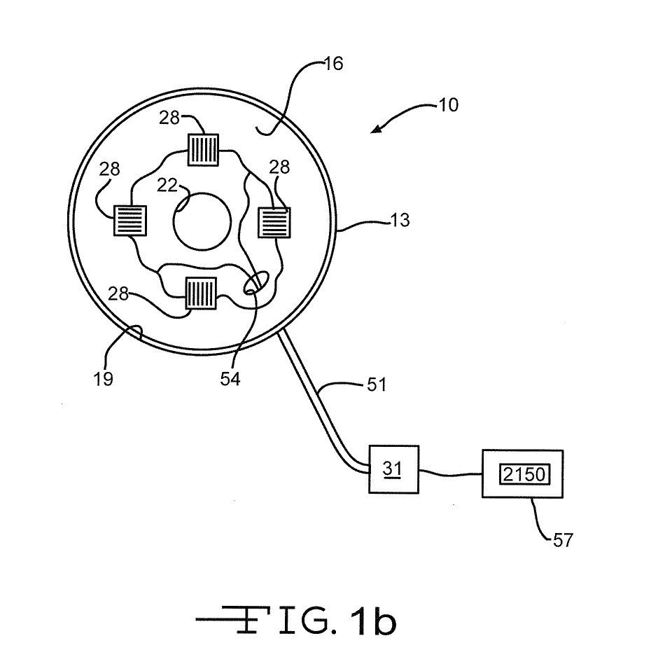

The invention may be embodied as a load cell 10 for weighing one or more objects. FIGS. 1a and 1b show a base 13 that may be used in a load cell 10 according to the invention. The base 13 has a curved surface 16, and at least one end-edge surface 19. For example, the base 13 may be a non-planar washer. The at least one end-edge 19 may define a closed-curve shape without abrupt changes in direction or corners. The base 13 may be substantially spherical or substantially conical in shape. Such a base 13 is substantially symmetrical about a plurality of intersecting axes, three of which are shown in FIG. 1A as A1, A2 and A3. The base 13 in FIGS. 1a and 1b has a hole 22, which is defined by a second end-edge surface 25. One or both of the end-edge surfaces 19, 25 may be used as a contacting surface in order to transfer force to or from the base 13.

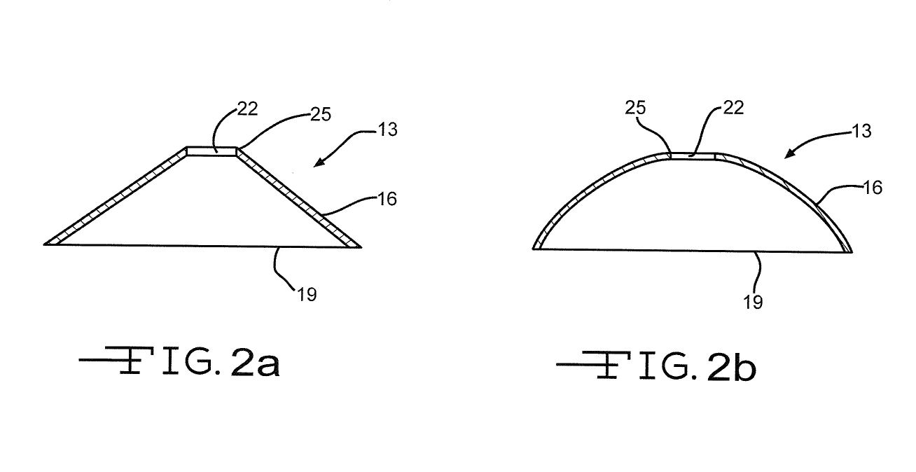

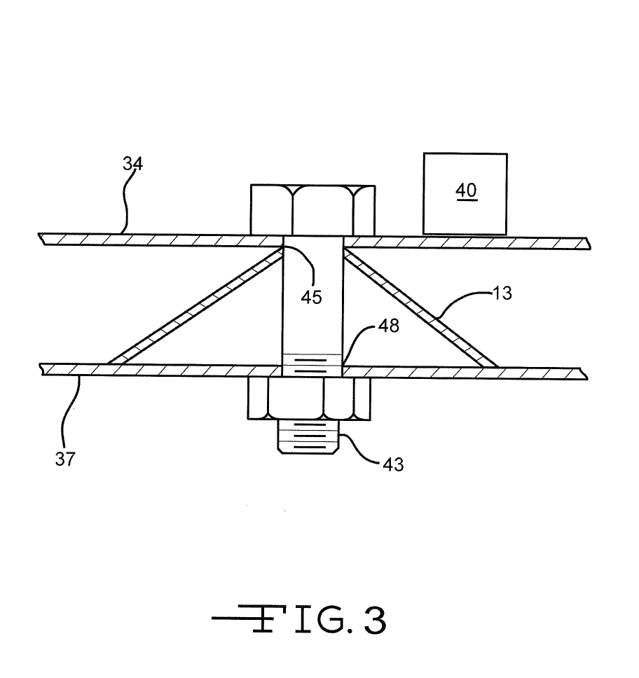

When viewed as in FIGS. 1a or 1b, the base 13 is disk shaped, but the invention is not limited a such a shape. FIGS. 1a and 1b show that one of the end-edge surfaces 19 of the the base 13 may be circular. FIG. 2a shows that the cross-section of the base 13 may be conically shaped. FIG. 2b shows that the cross-section of the base may be spherically shaped.

FIG. 1b shows that one or more strain gauges 28 may be fixed to the base 13 and electrically connected to form a Wheatstone bridge. The strain gauges 28 may be the metal film type, and may be fixed to the curved surface 16 using an adhesive. When the weight of an object is placed on the load cell 10, the weight of the object is supported by the base 13, and the base 13 is caused to flex. Flexing of the base 13 changes the resistance afforded by the strain gauges 28, and these resistance changes may be sensed by a suitable analyzing circuit 31, such as a voltmeter. When a voltmeter is used as the analyzing circuit 31, supporting the object 40 with the base 13 causes the resistance of the strain gauges 28 to change, which in turn causes the voltage sensed by the voltmeter to change, and the change in voltage may be correlated to a weight, and that correlated weight may be displayed to a person having an interest in knowing the weight of the object.

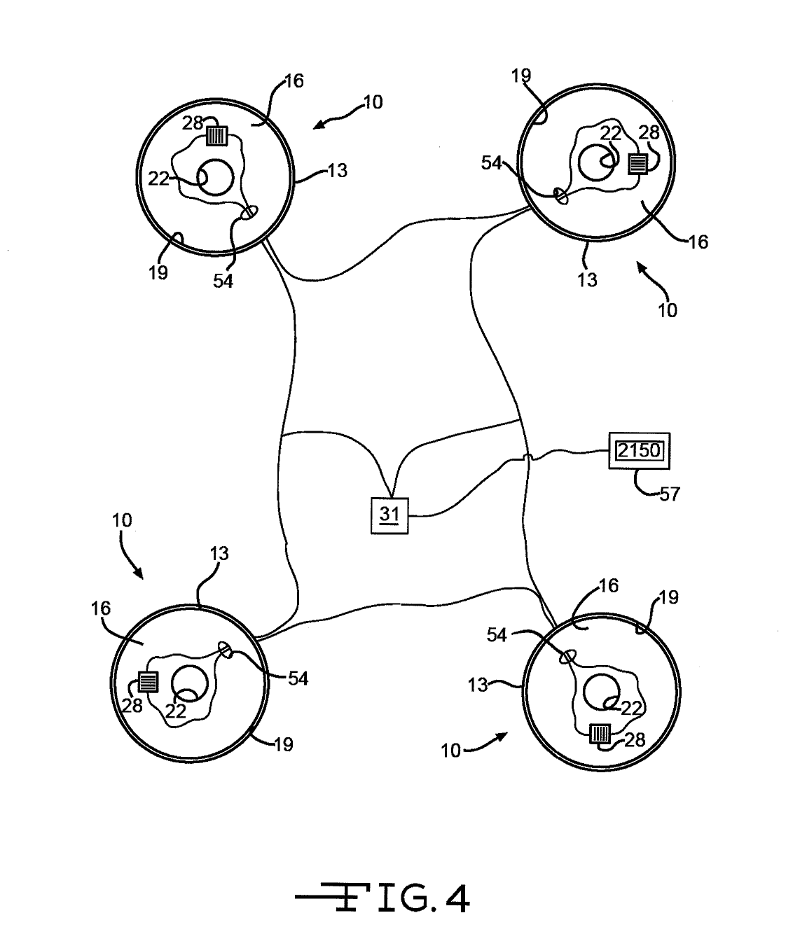

FIG. 3 is a partially cross-sectioned side view of a load cell 10 according to the invention. The base 13 is shown positioned between two plates 34, 37. When an object 40 is placed on the first plate 34, the weight of the object 40 (and the first plate 34) is transferred to the base 13. The weight of the first plate 34, the object 40 and the base 13 is transferred to the second plate 37. A fastener 43, such as a bolt and nut, may be used to hold the position of the base 13 relative to the plates 34, 37. Holes 45, 48 may be provided in the plates 34, 37 in order to permit the fastener 43 to extend through the plates 34, 37. In this fashion, the position of the plates 34, 37 relative to the base 13 may be substantially fixed.

The load cell 10 described above may be made to have a height of less than about 0.5 inches, and yet provide accurate weight readings in excess of 1,000 pounds. The small height of the load cell 10 makes it ideal for use in situations where there is a small amount of space. For example, the load cell 10 may be used on a building to measure the weight being supported by a floor of the building.

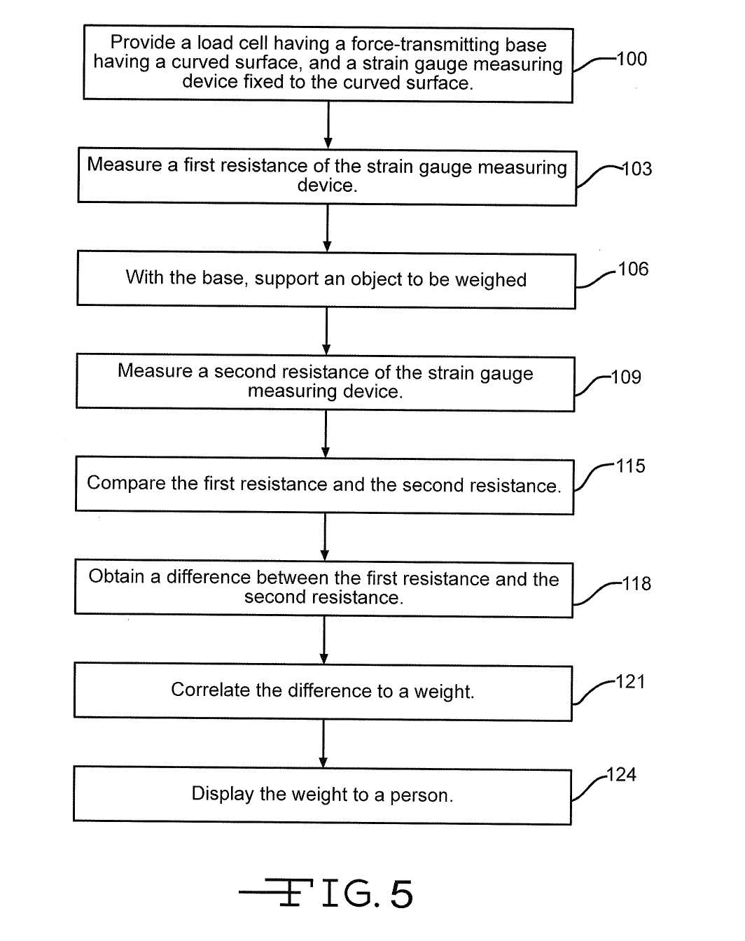

In one implementation of the invention, the Wheatstone bridge may be distributed across a number of bases 13. For example, a single strain gauge 28 may be fixed to a base 13 to form a single-gauge load cell 10. Three similar load cells 10 may be created. FIG. 4 depicts such an arrangement of load cells 10. Each of the single-gauge bases 13 may be used to support an object, such as the floor of a building. For example, each base 13 may be placed on an end of a support pillar for a building. When the four load cells 10 are electrically connected so that the strain gauges 28 form a Wheatstone bridge. The resulting distribution of four load cells 10 on four pillars may be used to measure the weight applied to a surface supported by the pillars. By distributing the load cells 10 in this fashion, a single analyzing circuit 31 may be used to measure the weight applied across a large area.

A transmission device 51 may be included. Such a transmission device 51 may be capable of transmitting a signal from the strain gauges 28 to an analyzing circuit 31, such as the voltmeter. The transmission device 51 may be an electric conductor extending between the strain gauge 28 and the analyzing circuit 31, and the wire may be capable of transmitting electricity between the analyzing circuit 31 and one or more load cells 10. Such a conductor may be routed from the load cells 10 through a hole 54 in the curved surface 16.

The invention may be embodied as a method. FIG. 5 depicts one such method. In that method, a load cell is provided 100. The load cell has a base with a curved surface, a strain gauge measuring device fixed to the base and a transmission device. The strain gauge measuring device may be a Wheatstone bridge, and it may be fixed to the curved surface. A first resistance of the strain gauge measuring device is measured 103, and then an object to be weighed is supported 106 by the base. Then a second resistance of the strain gauge measuring device is measured 109, and compared 112 to the first resistance to obtain 118 a resistance difference. The resistance difference is correlated 121 to a weight. The weight may be displayed 124 to a person for example via a monitor 57.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A load cell, comprising:
a force-transmitting base having a curved surface;
a strain gauge measuring device fixed to the curved surface, the measuring device including at least one strain gauge;
a transmission device, the transmission device being capable of transmitting a signal from the strain gauge to an analyzing circuit.

2. The load cell of claim 1, wherein the transmission device includes conductors extending between the load cell and the analyzing circuit.

3. The load cell of claim 2, wherein the conductors extend through a hole in the curved surface.

4. The load cell of claim 1, wherein the curved surface is spherical.

5. The load cell of claim 1, wherein the curved surface is conical.

6. The load cell of claim 1, further comprising a load-sending plate in contact with an end-edge of the curved surface.

7. The load cell of claim 1, further comprising a load-receiving plate in contact with an end-edge of the curved surface.

8. The load cell of claim 1, wherein the base has a hole extending therethrough.

9. The load cell of claim 8, further comprising:
a load-sending plate in contact with a first end-edge of the curved surface;
a load-receiving plate in contact with a second end-edge of the curved surface; and
a fastener extending through the plates and the hole so as to substantially fix the position of the plates relative to the base.

10. The load cell of claim 1, wherein the strain gauge measuring device is a Wheatstone bridge.

11. A method of weighing, comprising:
providing a load cell having a force-transmitting base having a curved surface, and a strain gauge measuring device fixed to the curved surface;
measuring a first resistance of the strain gauge measuring device;
supporting an object to be weighed with the base;
measuring a second resistance of the strain gauge measuring device;
comparing the first resistance and the second resistance to obtain a resistance difference;
correlating the resistance difference to a weight;
displaying the weight to a person.

12. A load cell, comprising:
a force-transmitting non-planar washer having a curved surface;
a strain gauge measuring device fixed to the curved surface, the measuring device including at least one strain gauge;
a transmission device, the transmission device being capable of transmitting a signal from the strain gauge to an analyzing circuit.

13. The load cell of claim 12, wherein the transmission device includes conductors extending between the load cell and the analyzing circuit.

14. The load cell of claim 13, wherein the conductors extend through a hole in the curved surface.

15. The load cell of claim 12, wherein the curved surface is spherical.

16. The load cell of claim 12, wherein the curved surface is conical.

17. The load cell of claim 12, further comprising a load-sending plate in contact with an end-edge contact surface of the curved surface.

18. The load cell of claim 12, further comprising a load-receiving plate in contact with an end-edge contact surface of the curved surface.

19. The load cell of claim 12, further comprising:
a load-sending plate in contact with a first end-edge contact surface of the curved surface;
a load-receiving plate in contact with a second end-edge contact surface of the curved surface; and
a fastener extending through the plates and the washer so as to substantially fix the position of the plates relative to the washer.

20. The load cell of claim 12, wherein the strain gauge measuring device is a Wheatstone bridge.
